(19) United States
(12) Patent Application Publication
(10) Pub. No.: US 2021/0249681 A1
(43) Pub. Date: Aug. 12, 2021

(54) Method for Preparing Connector-free Anode-supported Solid Oxide Fuel Cell Stack by Means of 3D Printing

(71) Applicant: SHANDONG UNIVERSITY OF TECHNOLOGY, Zibo (CN)

(72) Inventors: Jinjin ZHANG, Zibo (CN); Naitao YANG, Zibo (CN); Fanyong YU, Zibo (CN); Luyang WEI, Zibo (CN); Xiuxia MENG, Zibo (CN); Bo MENG, Zibo (CN)

(73) Assignee: SHANDONG UNIVERSITY OF TECHNOLOGY, Zibo (CN)

(21) Appl. No.: 17/049,786

(22) PCT Filed: Mar. 25, 2019
(86) PCT No.: PCT/CN2019/079470

§ 371 Date: Oct. 22, 2020

(30) Foreign Application Priority Data
Apr. 23, 2018 (CN) 201810364487.X

(51) Int. Cl. H01M 8/2435; B28B 1/00; H01M 4/90; H01M 4/88; H01M 8/0252; H01M 8/0236; H01M 8/2457; H01M 8/2483; B33Y 10/00; B33Y 80/00; H01M 8/2404

(52) U.S. Cl. CPC H01M 8/2435; B28B 1/001; H01M 4/9033; H01M 4/8846; H01M 8/0252; H01M 8/2404; H01M 8/2457; H01M 8/2483; B33Y 10/00; B33Y 80/00; H01M 8/0236

(57) ABSTRACT

The present disclosure belongs to the technical field of solid oxide fuel cell stacks, and particularly relates to a method for preparing a connector-free anode-supported solid oxide fuel cell stack by means of 3D printing. The method includes taking a mixed paste of an anode ceramic powder and a photosensitive resin as a raw material, and preparing a three-dimensional channel honeycomb-type anode-supported matrix by means of 3D printing; and obtaining an anode-supported solid oxide fuel cell by means of an impregnation method, effectively bringing same into contact, and abutting and sealing same in the order of a cathode, an anode and a cathode, and forming the connector-free anode-supported solid oxide fuel cell stack after performing connection in series.

### TECHNICAL FIELD

The present disclosure, belonging to the technical field of solid oxide fuel cell stacks, particularly relates to a method for preparing connector-free anode-supported solid oxide fuel cell stack by means of 3D printing.

### BACKGROUND ART

With the continuous improvement of the global economic aggregate, the conventional way of burning fossil fuel to provide power causes great pressure on the environment, while a solid oxide fuel cell (SOFC) is a device which can avoid the burning process, is not limited by Carnot cycle and directly converts chemical energy in the fuel into electric energy, and it can achieve the generating efficiency as high as 70% when generating electricity in combination with a gas turbine, and the waste heat has high quality, then if the waste heat is also reasonably utilized, the thermal efficiency thereof can reach 80% or more. With the advantages of high efficiency and low emission, the SOFC belongs to a new energy technology compatible with the environment.

Depending on the structural design, SOFCs can be divided into self-supported structures and externally supported structures. Self-supported structures can be divided into cathode-supported structures, electrolyte-supported structures and anode-supported structures. High-temperature SOFCs are mostly supported by electrolytes, while medium and low-temperature SOFCs, generally with thinner electrolyte, are more prone to use anode or cathode-supported structures. SOFCs can be divided into three types, namely, flat plate type, tubular type, and microtubular type according to shapes of the devices. The flat-plate SOFC has the advantages of a simple cell structure, a simple preparation process, and a low cost; a short path of a current passing through a connector, relatively high output power density of the cell, and good performance, but high-temperature inorganic sealing thereof is difficult, causing relatively poor thermal cycle performance, which affects the long-term working stability of the flat-plate SOFC. Compared with the flat-plate SOFC, the tubular SOFC and the microtubular SOFC have the greatest advantage that the single tube assembly is simple, without high-temperature sealing, a fuel gas and an oxidizing gas can be separated inside and outside the tube relying on their own structures, and the individual single-tube cells can be easily assembled into a large-scale fuel cell system in a series or parallel connection mode, with relatively stable mechanical stress and thermal stress. Generally, the voltage of the SOFC single cell is only about 0.7 V during operation, while the current can reach several amperes, therefore, in practical application, a plurality of single cells need to be connected in series and parallel to form a cell stack so as to improve an output voltage and an output power.

The conventional flat-plate SOFC stack unit has a three-layer flat-plate structure formed by an anode, an electrolyte, and a cathode, then a connecting plate with air passages carved on two sides is placed between two three-layer plates to form a series-connected electric pile structure, and the fuel gas and the oxidizing gas vertically cross and respectively flow through the air passages on an upper surface and a lower surface of the connecting plate; the tubular SOFC stack is also separated by a connector to form gas channels. The connector ensures a smooth circuit between two adjacent single cells, separates the fuel and air, and also plays a role in heat conduction, but the connector material is required to have good chemical stability, good thermal compatibility with other components and high mechanical performance. If a SOFC cell stack without connector can be prepared, not only a space of the cell stack can be reduced, and the power density of unit volume is improved, but also the trouble of searching for a properly matched connector material is avoided.

Chinese patent CN201608235U discloses a microtubular ceramic membrane fuel single cell stack, including a plurality of microtubular ceramic membrane fuel single cells and metal electric connection devices between the cells; each of the microtubular ceramic membrane fuel single cells includes a central conducting rod, and a plurality of ceramic membrane fuel single cell microtubes are fixed on an annular wall of the central conducting rod; the ceramic membrane fuel single cell microtube includes 3 layers, namely, an annular-outer-layer non-support electrode, an annular-inner-layer support electrode, and an annular electrolyte layer between the non-support electrode and the support electrode; the central conducting rod and the metal electric connecting device connect two electrodes of each microtubular ceramic membrane fuel single cell in parallel to form a cell stack. It has the advantages of simple preparation, high structural strength, high starting and heating speed, and high current output speed. However, in this structure, the single cells are fixed with the central conducting rod, so that the mass transfer efficiency is reduced, therefore, the cell output performance is relatively low. In addition, certain technical means need to be adopted for bonding, fixing, and sealing to form a stack in the process of assembling the single cells, and these techniques are time-consuming and labor-consuming, costly, unstable in batch performance, highly dependent on manual work, and unfavorable to industrialization of the solid oxide fuel cell.

Chinese patent CN104521053A discloses a solid oxide fuel cell stack, including a single cell, a cell frame for supporting a marginal portion of the single cell, a connecting member configured at a lower portion of the cell frame, a sealing member configured between the cell frame and the connecting member and a spacer member for maintaining a uniform interval between the cell frame and the connecting member. The spacer member is arranged in an area, which is not sealed by the sealing member, in a region between the cell frame and the connecting member, and is formed of mica or insulating ceramic. In this patent, the connecting member, the sealing member and the spacer member need to be used to assemble single cells into a cell stack, the assembly steps are multiple and complicated, and air tightness is easily deteriorated due to error in any link; moreover, in the thermal cycle process of the cell stack, the materials are peeled off and even cracked due to mismatching of the thermal expansion coefficients of the materials, the stability of the cell stack is poor, and the electrical property is also seriously reduced. If the cell stack can be directly prepared, without a connector for connecting the single cell, not only the time can be saved, and the working procedure can be simplified, but also higher electrical performance and long-term stability of the electric stack can be ensured.

The 3D printing technology, belonging to a rapid prototyping technology, is different from the conventional casting, forging and pressing, and machine tool machining. The core idea of this technology is that a material is deposited or stacked layer by layer to finally obtain a three-dimensional component plotted with digital drawing paper, and the basic principle thereof is: digital layering-physical laminating, that is, first, establishing a digital model for an object to be printed and carrying out digital layering to obtain a two-dimensional processing path or track of each layer; then, selecting a proper material and a corresponding process mode, to print layer by layer driven by the two-dimensional digital path of each layer obtained above, and finally accumulating and manufacturing the printed object. The 3D printing technology is a growing type processing mode, and is well applied to fields such as industrial modeling, packaging, manufacturing, building, art, medicine, aviation, aerospace, and film and television, but real industrial application is not started, and using the 3D printing for preparing the connector-free anode-supported SOFC cell stack is not reported.

### SUMMARY

The present disclosure aims at providing a method for preparing connector-free anode-supported solid oxide fuel cell stack by means of 3D printing, wherein a plurality of anode-supported solid oxide fuel cells are contacted, abutted and sealed effectively in a manner of cathode-anode-cathode, then series connection of the plurality of anode-supported solid oxide fuel cells can be achieved, without a connector, not only saving time, simplifying the working procedure, reducing the space of the cell stack, and improving the power density of a unit volume, but also ensuring the relatively high electrical performance and the long-term stability of the cell stack.

In the method for preparing a connector-free anode-supported solid oxide fuel cell stack by means of 3D printing in the present disclosure, a mixed paste of an anode ceramic powder body and a photosensitive resin is taken as a raw material, and a honeycomb-type anode-supported matrix with three-dimensional channels is prepared by means of 3D printing; an anode-supported solid oxide fuel cell is obtained by means of an impregnation method, and the anode-supported solid oxide fuel cells are contacted, abutted and sealed effectively in a manner of cathode-anode-cathode, so that the connector-free anode-supported solid oxide fuel cell stack is formed after performing connection in series. The method includes steps of:

(1) with the mixed paste of the anode ceramic powder body and the photosensitive resin being taken as the raw material, designing a geometrical configuration of the cell stack using 3D drawing software, slicing and layering the geometrical configuration of the cell stack by means of 3D printing software, and performing layered printing using a 3D printer to prepare a green body of a honeycomb-type anode-supported matrix with three-dimensional channels in a manner of one-step forming;

(2) debinding and sintering the green body to obtain the honeycomb-type anode-supported matrix with three-dimensional channels;

(3) sequentially depositing an electrolyte layer and a cathode layer on the honeycomb-type anode-supported matrix with three-dimensional channels by means of an impregnation method, to obtain an anode-supported solid oxide fuel cell; and

(4) making a plurality of the anode-supported solid oxide fuel cells to be contacted, abutted and sealed effectively in a manner of cathode-anode-cathode, to realize series connection of the plurality of the anode-supported solid oxide fuel cells, and form the connector-free anode-supported solid oxide fuel cell stack.

In the above:

a mass percentage of the anode ceramic powder body to the photosensitive resin is 70:21-70:30.

A material used for the anode ceramic powder body is one or more of conductive ceramic materials or mixed conductor oxide materials; the conductive ceramic materials are Ni-based cermet materials, Ag-based composite anode materials or Cu-based cermet anode materials; mixed conductor oxide materials are LaCrO₃-based series, SrTiO₃-based series or Sr₂MgMoO₃-based series oxide materials; and the anode ceramic powder body and the electrolyte layer are of the same type of material;

a material used for the electrolyte layer is one or more of zirconium oxide-based oxides, cerium oxide-based oxides, bismuth oxide-based oxides, lanthanum gallate-based oxides, ABO₃ perovskite-type structure electrolytes or apatite type electrolytes of a general formula Ln₁₀(MO₄)₆O₂; the zirconium oxide-based oxides, the cerium oxide-based oxides, and the bismuth oxide-based oxides have a structure of XₐY₁₋ₐO_{2-δ,} wherein,

X is one or more of calcium, yttrium, scandium, samarium, gadolinium or praseodymium metallic elements;

Y is one or more of zirconium, cerium or bismuth metallic elements;

δ is the number of oxygen deficiency, 0≤a≤1;

a material used for the cathode layer is one or more of a doped perovskite-type ceramic with a structure of ABO_{3-δ,} a double perovskite-type ceramic with a structure of A₂B₂O_{5+δ,} an R-P-type perovskite-like ceramic with a structure of A₂BO_{4+δ} or a superconducting material, wherein

A is one or more of lanthanum, cerium, praseodymium, neodymium, samarium, europium, gadolinium, terbium, dysprosium, holmium, erbium, thulium, ytterbium, lutetium, calcium, strontium or barium;

B is one or more of scandium, titanium, vanadium, chromium, manganese, iron, cobalt, nickel, copper, zinc, gallium, aluminum, yttrium, zirconium, niobium, molybdenum, hafnium, tantalum, tungsten or rhenium;

δ is the number of oxygen deficiency;

the superconducting material includes YSr₂Cu₂MO_{7+δ,} YBaCo₃ZnO_{7-δ} and Ca₃Co₄O_{9-δ,} wherein M is iron or cobalt; δ is the number of oxygen deficiency;

all materials used for the anode ceramic powder body, the electrolyte layer and the cathode layer have a particle size of 0.02-10 μm.

The 3D drawing software is preferably 3Dmax, Catia, UG and so on.

The connector-free anode-supported solid oxide fuel cell stack is formed by effectively contacting, abutting and sealing a plurality of anode-supported solid oxide fuel cells, and connecting them in series in a manner of cathode-anode-cathode; each cell includes multiple groups of ceramic microtubes that are arranged in parallel to each other, the intratubal fluid channels are formed inside the ceramic microtubes, each group of the ceramic microtubes is arranged on respective ceramic rib plates, each group of ceramic microtubes includes a plurality of ceramic microtubes with tube openings of the ceramic microtubes being linearly arranged, the multiple groups of ceramic microtubes arranged in parallel are separated from each other, forming the inter-tube fluid channels; upper ends and lower ends of the ceramic microtubes are connected with the ceramic tube plates to fixedly connect the ceramic microtubes into a bundle, with an end face being in a honeycomb shape, two sides of two ceramic tube plates are connected by two ceramic support plates, and the ceramic support plates are perpendicular to the ceramic tube plates, and the ceramic tube plates, the ceramic support plates, the ceramic microtubes and the ceramic rib plates are all integrally molded by 3D printing;

the inter-tube fluid channels and the intratubal fluid channels are straight-through channels or S-shaped zigzag channels.

When the electrolyte layer and the cathode layer are sequentially deposited on the honeycomb-type anode-supported matrix with three-dimensional channels, impregnation is performed in one of two manners including an impregnation manner I or an impregnation manner II:

the impregnation manner I: sequentially impregnating the electrolyte layer and the cathode layer on an outer surface ABCD of the ceramic tube plate where upper-end tube openings of the intratubal fluid channels and the ceramic microtubes are located;

the impregnation manner II: sequentially impregnating the electrolyte layer and the cathode layer on a left end face AA′D′D of end faces where the inter-tube fluid channels and the ceramic rib plates are located;

when the impregnation manner I is used, in an impregnation process, a blank area is reserved inside the intratubal fluid channel, preventing short circuit due to contact of the cathode and the anode, and this blank area is only impregnated with the electrolyte layer, but no cathode layer; the blank area is an annular area, located at the lower end of the intratubal fluid channel, and the annular area has a height of 0.1-1 mm;

when the impregnation manner II is used, in an impregnation process, a blank area is reserved inside the inter-tube fluid channels, preventing short circuit due to contact of the cathode and the anode, and this blank area is only impregnated with the electrolyte layer, but no cathode layer; the blank area is an area of all the inter-tube fluid channels formed between an end face resulted from translating a right end face BB′C′C of end faces where the ceramic rib plates are located towards the interior of the cell by 0.1-1 mm and the right end face BB′C′C.

The blank area is formed by means of wax sealing, and during impregnation, the blank area is blocked using wax.

The connector-free anode-supported solid oxide fuel cell stack is formed in a manner which is different depending on the different impregnation manner:

when the impregnation manner I is used, an outer surface ABCD of the ceramic tube plate where upper-end tube openings of the ceramic microtubes of one anode-supported solid oxide fuel cell are located and an outer surface A′B′C′D′ of the ceramic tube plate where lower-end tube openings of the ceramic microtubes of another anode-supported solid oxide fuel cell are located are effectively contacted, abutted and sealed, in a manner of cathode-anode-cathode, to form the connector-free anode-supported solid oxide fuel cell stack;

when the impregnation manner II is used, a left end face AA′D′D of end faces where the ceramic rib plates of one anode-supported solid oxide fuel cell are located and a right end face BB′C′C of end faces where the ceramic rib plates of another anode-supported solid oxide fuel cell are located are effectively contacted, abutted and sealed, in a manner of cathode-anode-cathode, to form the connector-free anode-supported solid oxide fuel cell stack.

When the plurality of anode-supported solid oxide fuel cells are connected, positions of the blank areas in each anode-supported solid oxide fuel cell are the same.

A fuel gas is introduced into a side of the honeycomb-type anode-supported matrix with three-dimensional channels, and an oxidizing gas or air is introduced into a side of the cathode layer.

The debinding refers to heat treatment in a certain atmosphere at a temperature lower than 800° C. for 5-30 h; the sintering refers to heat treatment in a certain atmosphere at a temperature of 800-1600° C. for 2-10 h, wherein the atmosphere during debinding is vacuum atmosphere, normal pressure atmosphere or inert gas atmosphere; the atmosphere during sintering is oxidizing atmosphere or ordinary atmosphere.

The electrolyte layer has a thickness of 1-20 μm; and the cathode layer is a porous layer, with a thickness of 5-20 μm.

The impregnation method is: formulating the ceramic powder body material, a solvent, and an additive into a stable suspended emulsion, coating the emulsion on the support matrix, followed by drying, sintering or reduction heat treatment; types of the solvent and the additive are conventional options for those skilled in the art.

Beneficial effects of the present disclosure are as follows:

in the present disclosure, the mixed paste of the anode ceramic powder body and the photosensitive resin is taken as the raw material, an anode-supported solid oxide fuel cell module having a three-dimensional channel structure is prepared by layered printing of a printer using 3D slicing software, then the connector-free anode-supported solid oxide fuel cell stack is prepared by accumulation, which solves several important problems in the process of preparing the cell stack:

(1) With the 3D printing technology the inter-microtube three-dimensional channels can be designed and prepared, not only ensuring strength of the support matrix, but also improving the mass transfer efficiency.

(2) There is no need to prepare single hollow fiber ceramic tube, but the honeycomb-type anode-supported matrix with three-dimensional channels is molded and prepared directly by the powder body material, which omits the process of preparing single cells and then assembling the single cells, and simplifies the preparation flow, not only greatly improving the production efficiency and saving the preparation cost, but also avoiding the problem of unstable batches due to manual assembling, and reducing influence of human factors on product quality.

(3) A plurality of anode-supported solid oxide fuel cells are effectively contacted, abutted and sealed in a manner of cathode-anode-cathode, then series connection of the plurality of anode-supported solid oxide fuel cells can be achieved, thus forming the cell stack, without the need of looking for a suitably matched connector material, and avoiding peeling off and even cracking of various materials due to mismatching of thermal expansion coefficients of various materials during the thermal circulation of the cell stack, which causes the phenomena of poor cell stack stability, and seriously reduced electrical property. The connector-free anode-supported solid oxide fuel cell stack not only facilitates reducing the space of the cell stack, but also improves the power density of a unit volume.

### BRIEF DESCRIPTION OF DRAWINGS

FIG. 1 is a structural schematic diagram of a model of a honeycomb-type anode-supported matrix with three-dimensional channels of the present disclosure;

FIG. 2 is a structural schematic diagram of a connector-free anode-supported solid oxide fuel cell stack in Embodiment 1;

FIG. 3 is a structural schematic diagram of the inside of the connector-free anode-supported solid oxide fuel cell stack in Embodiment 1;

FIG. 4 is a schematic diagram of the connector-free anode-supported solid oxide fuel cell stack in Embodiment 2; and

FIG. 5 is a structural schematic diagram of the inside of the connector-free anode-supported solid oxide fuel cell stack in Embodiment 2;

In FIGS. 1-5, 1. blank area; 2. cathode layer; 3. electrolyte layer; 4. anode-supported matrix; 5. inter-tube fluid channel; 6. intratubal fluid channel; 7. ceramic support plate; 8. ceramic rib plate; 9. ceramic microtube; 10. ceramic tube plate.

### DETAILED DESCRIPTION OF EMBODIMENTS

Below the present disclosure is further described in combination with the embodiments.

### Embodiment 1

100 g Ni−GDC (Gd_{0.1}Ce_{0.9}O_{2-δ}) anode ceramic powder body (with a particle size of 800 nm) is mixed with a photosensitive resin and ethanol according to the proportion of 70 wt. % the powder body, 27.3 wt. % the photosensitive resin and 2.7 wt. % the ethanol, and the mixture is stirred and mixed for 12 h, and then ball-milled for 4 h to form a uniform paste. A model of a honeycomb-type anode-supported matrix with three-dimensional channels is established by utilizing Catia software, wherein the model is 2 cm in both length and width, and 1 cm in height, has 28 ceramic microtubes in a longitudinal direction to provide intratubal fluid channels, and 6 channels in a transverse direction to provide inter-tube fluid channels, referring to FIG. 1 for a structural schematic diagram thereof, and the model is led into CreationWorkshop software for slicing and printing. An AOTOCERA ceramic 3D printer of Beijing Ten Dimensions Technology Co. Ltd. is used as the 3D printer. The paste is added into a resin tank, and the three-dimensional printer is controlled by a computer to mold the paste by layered printing according to a designed three-dimensional entity model structure diagram, to obtain a green body of the honeycomb-type anode-supported matrix with three-dimensional channels. After the printing is completed, the green body of the honeycomb-type anode-supported matrix with three-dimensional channels is put into industrial alcohol to clean, to remove uncured paste, and is naturally dried in the air at room temperature, then is placed in a programmed temperature-control electric furnace, heated to 800° C. at a heating rate of 0.5° C./min under a vacuum condition, and the temperature is preserved for 2 hours so as to remove an organic binder in the green body. Then the debinded body is heated to 1100° C. at a heating rate of 2° C./min and 4 h plateau at 1100° C. to ensure the densification and high strength of the sintered body. Finally the sintered body is cooled to room temperature at a cooling rate of 2° C./min to obtain the honeycomb-type anode-supported matrix with three-dimensional channels.

On an outer surface ABCD of a ceramic tube plate 10 where upper-end tube openings of the intratubal fluid channels 6 and the ceramic microtubes 9 are located, a dense GDC electrolyte layer and a porous BSCF (Ba_{0.6}Sr_{0.4}Co_{0.5}Fe0.5O_{3-δ}) cathode layer are sequentially impregnated and deposited, to form an anode-supported solid oxide fuel cell. In the impregnation process, annular blank areas with height of 1 mm are reserved at lower ends of the intratubal fluid channels 6, and such annular blank area is only impregnated with the GDC electrolyte layer, but no BSCF porous cathode layer.

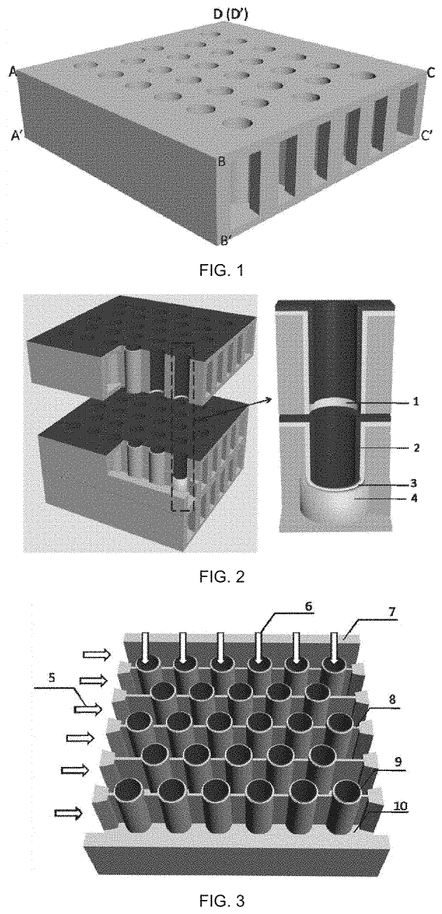

The outer surface ABCD of the ceramic tube plate 10 where upper-end tube openings of the ceramic microtubes 9 of one cell are located and an outer surface A′B′C′D′ of the ceramic tube plate 10 where lower-end tube openings of the ceramic microtubes 9 of another cell are located are effectively contacted, abutted and sealed by using a silver paste, realizing series connection of a plurality of cells without a connector, and forming a connector-free anode-supported solid oxide fuel cell stack, referring to FIG. 2. The dense electrolyte layer has a thickness of 8 μm, and the cathode layer has a thickness of 10 μm.

A silver wire is placed on the outer surface ABCD of an uppermost cell of the connector-free anode-supported solid oxide fuel cell stack, and a cathode current is led out through the silver wire; a silver wire is placed on the outer surface A′B′C′D′ of the lowermost cell of the connector-free anode-supported solid oxide fuel cell stack, and an anode current is led out through the silver wire.

In Embodiment 1, the connector-free anode-supported solid oxide fuel cell stack is formed by effectively contacting, abutting, and sealing a plurality of anode-supported solid oxide fuel cells, and connecting them in series in a manner of cathode-anode-cathode; each cell includes multiple groups of ceramic microtubes 9 which are arranged in parallel to each other, the intratubal fluid channels 6 are formed inside the ceramic microtubes 9, each group of ceramic microtubes 9 is arranged on respective ceramic rib plates 8, each group of ceramic microtubes 9 includes a plurality of ceramic microtubes 9 with the tube openings of the ceramic microtubes being linearly arranged, the multiple groups of ceramic microtubes 9 which are arranged in parallel are separated from each other, forming the inter-tube fluid channels 5; upper ends and lower ends of the ceramic microtubes 9 are connected with the ceramic tube plates 10 to fixedly connect the ceramic microtubes 9 into a bundle, with an end face being in a honeycomb shape, two sides of the two ceramic tube plates 10 are connected by two ceramic support plates 7, and the ceramic support plates 7 are perpendicular to the ceramic tube plates 10. The ceramic tube plates 10, the ceramic support plates 7, the ceramic microtubes 9 and the ceramic rib plates 8 are all integrally molded by 3D printing, referring to FIG. 3 for a structure thereof.

### Embodiment 2

70 g Ni—YSZ (Y_{0.08}Zr_{0.92}O_{2-δ}) anode ceramic powder body (with a particle size of 500 nm) is uniformly mixed with 7 g starch by a mixer. 70 wt. % the powder body, 27.3 wt. % a photosensitive resin, 1.4 wt. % ethanol and 1.3 wt. % PEG are stirred and mixed for 12 h, and then ball-milled for 4 h to form a uniform paste. A model of a honeycomb-type anode-supported matrix with three-dimensional channels is established by utilizing UG software, wherein the model is 2 cm in both length and width, and 1 cm in height, has 28 ceramic microtubes in a longitudinal direction to provide intratubal fluid channels, and 6 channels in a transverse direction to provide inter-tube fluid channels, referring to FIG. 1 for a structural schematic diagram thereof, and the model is led into CreationWorkshop software for slicing and printing. An AOTOCERA ceramic 3D printer of Beijing Ten Dimensions Technology Co. Ltd. is used as the 3D printer. The paste is added into a resin tank, and the three-dimensional printer is controlled by a computer to mold the paste by layered printing according to a designed three-dimensional entity model structure diagram, to obtain a green body of the honeycomb-type anode-supported matrix with three-dimensional channels. After the printing is completed, the green body of the honeycomb-type anode-supported matrix with three-dimensional channels is put into industrial alcohol to clean, to remove uncured paste, and is naturally dried in the air at room temperature, then is placed in a programmed temperature-control electric furnace, heated to 600° C. at a heating rate of 0.5° C./min under a vacuum condition with holding time of 2 h at 600° C. so as to remove an organic binder in the green body of the honeycomb-type anode-supported matrix with three-dimensional channels. Then the debinded body of the honeycomb-type anode-supported matrix with three-dimensional channels is put into a sintering furnace, and heated to 1200° C. at a heating rate of 2° C./min in an air atmosphere, and 4 h plateau at 1200° C. so that the body is fully sintered, and finally the sintered body is cooled to room temperature at a cooling rate of 2° C./min to obtain the honeycomb-type anode-supported matrix with three-dimensional channels.

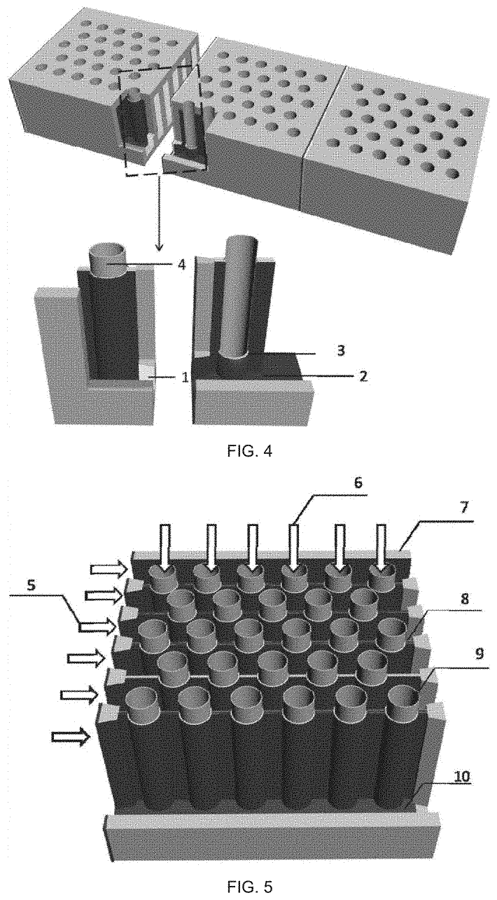

On a left end face AA′D′D of end faces where the inter-tube fluid channels 5 and the ceramic rib plates 8 are located, a dense YSZ electrolyte layer and a porous LSM (La_{0.8}Sr_{0.2}MnO_{3-δ}) cathode layer are sequentially impregnated and deposited, to form an anode-supported solid oxide fuel cell. In the impregnation process, a blank area is left at a right ends of the inter-tube fluid channels 5, this blank area is only impregnated with the YSZ electrolyte layer, but no LSM cathode layer, and the blank area is an area of all the inter-tube fluid channels 5, which area is formed between an end face resulted from translating a right end face BB′C′C of end faces where the ceramic rib plates 8 are located towards the interior of the cell by 1 mm and the right end face BB′C′C. The left end face AA′D′D of the end faces where the ceramic rib plates 8 of one cell are located and the right end face BB′C′C of the end faces where the ceramic rib plates 8 of another cell are located are effectively contacted, abutted and sealed by using a silver paste, thereby realizing series connection of a plurality of cells without a connector, and forming a connector-free anode-supported solid oxide fuel cell stack, referring to FIG. 4. The dense electrolyte layer has a thickness of 10 μm, and the cathode layer has a thickness of 10 μm.

A silver wire is placed inside the ceramic microtube 9 of a leftmost cell of the connector-free anode-supported solid oxide fuel cell stack, and an anode current is led out through the silver wire; a silver wire is placed inside the inter-tube fluid channel 5 of a rightmost cell of the connector-free anode-supported solid oxide fuel cell stack, and a cathode current is led out through the silver wire.

In Embodiment 2, the connector-free anode-supported solid oxide fuel cell stack is formed by effectively contacting, abutting, and sealing a plurality of anode-supported solid oxide fuel cells, and connecting them in series in the manner of cathode-anode-cathode; each cell includes multiple groups of ceramic microtubes 9 which are arranged in parallel to each other, the intratubal fluid channels 6 are formed inside the ceramic microtubes 9, each group of ceramic microtubes 9 is arranged on respective ceramic rib plates 8, each group of ceramic microtubes 9 includes a plurality of ceramic microtubes 9 with the tube openings of the ceramic microtubes being linearly arranged, the multiple groups of ceramic microtubes 9 which are arranged in parallel are separated from each other, forming the inter-tube fluid channels 5; upper ends and lower ends of the ceramic microtubes 9 are connected with the ceramic tube plates 10 to fixedly connect the ceramic microtubes 9 into a bundle, with an end face being in a honeycomb shape, two sides of the two ceramic tube plates 10 are connected by two ceramic support plates 7, and the ceramic support plates 7 are perpendicular to the ceramic tube plates 10. The ceramic tube plates 10, the ceramic support plates 7, the ceramic microtubes 9 and the ceramic rib plates 8 are all integrally molded by 3D printing, referring to FIG. 5 for a structure thereof.

### Embodiment 3

70 g Ni-SDC (Sm_{0.2}Ce_{0.8}O_{2-δ}) anode ceramic powder body (with a particle size of 500 nm) is uniformly mixed with 7 g starch by a mixer. 70 wt. % the powder body, and 30 wt. % a photosensitive resin are stirred and mixed for 20 h, and then ball-milled for 2 h to form a uniform paste. A model of a honeycomb-type anode-supported matrix with three-dimensional channels is established by utilizing 3DMax software, wherein the model is 2 cm in both length and width, and 1 cm in height, has 28 ceramic microtubes in a longitudinal direction to provide intratubal fluid channels, and 6 channels in a transverse direction to provide inter-tube fluid channels, referring to FIG. 1 for a structural schematic diagram thereof, and the model is led into CreationWorkshop software for slicing and printing. An AOTOCERA ceramic 3D printer of Beijing Ten Dimensions Technology Co. Ltd. is used as the 3D printer. The paste is added into a resin tank, and the three-dimensional printer is controlled by a computer to mold the paste by layered printing according to a designed three-dimensional entity model structure diagram, to obtain a green body of a honeycomb-type anode-supported matrix with three-dimensional channels. After the printing is completed, the green body of the honeycomb-type anode-supported matrix with three-dimensional channels is put into industrial alcohol to clean, to remove uncured paste, and is naturally dried in the air at room temperature, then is placed in a programmed temperature-control electric furnace, and heated to 600° C. at a heating rate of 0.5° C./min under a vacuum condition with holding time of 5 h at 600° C. so as to remove an organic binder in the green body of the honeycomb-type anode-supported matrix with three-dimensional channels. Then the debinded body of the honeycomb-type anode-supported matrix with three-dimensional channels is put into a sintering furnace, and heated to 1100° C. at a heating rate of 2° C./min in an air atmosphere with 4 h plateau at 1100° C. so that the body is fully sintered, and finally the sintered body is cooled to room temperature at a cooling rate of 2° C./min to obtain the honeycomb-type anode-supported matrix with three-dimensional channels.

On a left end face AA′D′D of end faces where the inter-tube fluid channels 5 and the ceramic rib plates 8 are located, a dense YSZ electrolyte layer and a porous LSCF (La_{0.6}Sr_{0.4}CO_{0.2}Fe_{0.8}O_{3-δ}) cathode layer are sequentially impregnated and deposited, to form an anode-supported solid oxide fuel cell. In the impregnation process, a blank area is left at right ends of the inter-tube fluid channels 5, this blank area is only impregnated with the YSZ electrolyte layer, but no LSCF cathode layer, and the blank area is the area of all the inter-tube fluid channels 5 formed between an end face resulted from translating a right end face BB′C′C of end faces where the ceramic rib plates 8 are located towards the interior of the cell by 1 mm and the right end face BB′C′C. The left end face AA′D′D of the end faces where the ceramic rib plates 8 of one cell are located and the right end face BB′C′C of the end faces where the ceramic rib plates 8 of another cell are located are effectively contacted, abutted and sealed by using a silver paste, realizing series connection of a plurality of cells without a connector, and forming a connector-free anode-supported solid oxide fuel cell stack. The dense electrolyte layer has a thickness of 10 μm, and the cathode layer has a thickness of 12 μm.

A silver wire is placed inside the ceramic microtube 9 of a leftmost cell of the connector-free anode-supported solid oxide fuel cell stack, and an anode current is led out through the silver wire; a silver wire is placed inside the inter-tube fluid channel 5 of a rightmost cell of the connector-free anode-supported solid oxide fuel cell stack, and a cathode current is led out through the silver wire.

In Embodiment 3, the connector-free anode-supported solid oxide fuel cell stack is formed by effectively contacting, abutting, and sealing a plurality of anode-supported solid oxide fuel cells, and connecting them in series in the manner of cathode-anode-cathode; each cell includes multiple groups of ceramic microtubes 9 which are arranged in parallel to each other, the intratubal fluid channels 6 are formed inside the ceramic microtubes 9, each group of ceramic microtubes 9 is arranged on respective ceramic rib plates 8, each group of ceramic microtubes 9 includes a plurality of ceramic microtubes 9 with the tube openings of the ceramic microtubes being linearly arranged, the multiple groups of ceramic microtubes 9 which are arranged in parallel are separated from each other, forming the inter-tube fluid channels 5; upper ends and lower ends of the ceramic microtubes 9 are connected with the ceramic tube plates 10 to fixedly connect the ceramic microtubes 9 into a bundle, with an end face being in a honeycomb shape, two sides of the two ceramic tube plates 10 are connected by two ceramic support plates 7, and the ceramic support plates 7 are perpendicular to the ceramic tube plates 10. The ceramic tube plates 10, the ceramic support plates 7, the ceramic microtubes 9 and the ceramic rib plates 8 are all integrally molded by 3D printing.

1. A method for preparing a connector-free anode-supported solid oxide fuel cell stack by means of 3D printing, wherein taking a mixed paste of an anode ceramic powder body and a photosensitive resin as a raw material, a honeycomb-type anode-supported matrix with three-dimensional channels is prepared by means of 3D printing; and anode-supported solid oxide fuel cells are obtained by means of an impregnation method, and the anode-supported solid oxide fuel cells are abutted and sealed effectively in a manner of cathode-anode-cathode, so that the connector-free anode-supported solid oxide fuel cell stack is formed after performing connection in series.

2. The method for preparing a connector-free anode-supported solid oxide fuel cell stack by means of 3D printing according to claim 1, comprising steps of:
(1) with the mixed paste of the anode ceramic powder body and the photosensitive resin being taken as the raw material, designing a geometrical configuration of a cell stack using 3D drawing software, slicing and layering the geometrical configuration of the cell stack by means of 3D printing software, and performing layered printing using a 3D printer to prepare a green body of the honeycomb-type anode-supported matrix with three-dimensional channels in a manner of one-step forming;
(2) debinding and sintering the green body to obtain the honeycomb-type anode-supported matrix with three-dimensional channels;
(3) sequentially depositing an electrolyte layer and a cathode layer on the honeycomb-type anode-supported matrix with three-dimensional channels by means of the impregnation method, to obtain each of the anode-supported solid oxide fuel cells; and
(4) effectively abutting and sealing a plurality of the anode-supported solid oxide fuel cells in the manner of cathode-anode-cathode, to realize a series connection of the plurality of the anode-supported solid oxide fuel cells, and form the connector-free anode-supported solid oxide fuel cell stack.

3. The method for preparing a connector-free anode-supported solid oxide fuel cell stack by means of 3D printing according to claim 2, wherein a mass percentage of the anode ceramic powder body to the photosensitive resin is 70:21-70:30.

4. The method for preparing a connector-free anode-supported solid oxide fuel cell stack by means of 3D printing according to claim 2, wherein
(1) a material used for the anode ceramic powder body is one or more selected from the group consisting of conductive ceramic materials and mixed conductor oxide materials; the conductive ceramic materials are selected from the group consisting of Ni-based cermet materials, Ag-based composite anode materials and Cu-based cermet anode materials; the mixed conductor oxide materials are selected from the group consisting of LaCrO₃-based series, SrTiO3-based series and Sr2MgMoO₃-based series oxide materials; and the anode ceramic powder body and the electrolyte layer are of a same type of material;
(2) a material used for the electrolyte layer is one or more selected from the group consisting of zirconium oxide-based oxides, cerium oxide-based oxides, bismuth oxide-based oxides, lanthanum gallate-based oxides, ABO₃ perovskite-type structure electrolytes and apatite type electrolytes of a general formula Ln₁₀(MO₄)₆O₂; and the zirconium oxide-based oxides, the cerium oxide-based oxides, and the bismuth oxide-based oxides have a structure of XₐY₁₋ₐO_{2-δ}, wherein
X is one or more selected from the group consisting of calcium, yttrium, scandium, samarium, gadolinium and praseodymium metallic elements;
Y is one or more selected from the group consisting of zirconium, cerium and bismuth metallic elements; and
δ is a number of oxygen deficiency, 0≤a≤1; and
(3) a material used for the cathode layer is one or more selected from the group consisting of a doped perovskite-type ceramic with a structure of ABO_{3-δ}, a double perovskite-type ceramic with a structure of A₂B₂O_{5+δ}, an R—P-type perovskite-like ceramic with a structure of A₂BO_{4+δ}and a superconducting material, wherein
A is one or more selected from the group consisting of lanthanum, cerium, praseodymium, neodymium, samarium, europium, gadolinium, terbium, dysprosium, holmium, erbium, thulium, ytterbium, lutetium, calcium, strontium and barium;
B is one or more selected from the group consisting of scandium, titanium, vanadium, chromium, manganese, iron, cobalt, nickel, copper, zinc, gallium, aluminum, yttrium, zirconium, niobium, molybdenum, hafnium, tantalum, tungsten and rhenium;
δ is the number of oxygen deficiency;
the superconducting material comprises YSr₂Cu₂MO_{7+δ}, YBₐCo₃ZnO_{7-δ} and Ca₃Co₄O_{9-δ}, wherein M is iron or cobalt; δ is the number of oxygen deficiency;
all materials used for the anode ceramic powder body, the electrolyte layer and the cathode layer have a particle size of 0.02-10 μm.

5. The method for preparing a connector-free anode-supported solid oxide fuel cell stack by means of 3D printing according to claim 2, wherein the connector-free anode-supported solid oxide fuel cell stack is formed by effectively abutting and sealing, in the manner of cathode-anode-cathode, a plurality of the anode-supported solid oxide fuel cells in a manner of series connection; each cell comprises multiple groups of ceramic microtubes that are arranged in parallel to each other, intratubal fluid channels are formed inside the ceramic microtubes, each group of the ceramic microtubes is arranged on respective ceramic rib plates, each group of the ceramic microtubes comprises a plurality of the ceramic microtubes with tube openings of the ceramic microtubes being linearly arranged, the multiple groups of the ceramic microtubes arranged in parallel are separated from each other, to form inter-tube fluid channels; and upper ends and lower ends of the ceramic microtubes are connected with ceramic tube plates to fixedly connect the ceramic microtubes into a bundle, with an end face being in a honeycomb shape, two sides of two ceramic tube plates are connected by two ceramic support plates, and the ceramic support plates are perpendicular to the ceramic tube plates, and the ceramic tube plates, the ceramic support plates, the ceramic microtubes and the ceramic rib plates are all integrally molded by 3D printing; and
the inter-tube fluid channels and the intratubal fluid channels are straight-through channels or S-shaped zigzag channels.

6. The method for preparing a connector-free anode-supported solid oxide fuel cell stack by means of 3D printing according to claim 2, wherein
when the electrolyte layer and the cathode layer are sequentially deposited on the honeycomb-type anode-supported matrix with three-dimensional channels, impregnation is performed in one of two manners including an impregnation manner I or an impregnation manner II:
the impregnation manner I: sequentially impregnating the electrolyte layer and the cathode layer on an outer surface ABCD of a ceramic tube plate where upper-end tube openings of the intratubal fluid channels and the ceramic microtubes are located; and
the impregnation manner II: sequentially impregnating the electrolyte layer and the cathode layer on a left end face AA′D′D of end faces where the inter-tube fluid channels and the ceramic rib plates are located;
wherein when the impregnation manner I is used, in an impregnation process, a blank area is reserved inside each of the intratubal fluid channels, and the blank area is only impregnated with the electrolyte layer, but no cathode layer; when the impregnation manner II is used, in an impregnation process, a blank area is reserved inside the inter-tube fluid channels, and the blank area is only impregnated with the electrolyte layer, but no cathode layer; and
a fuel gas is introduced into a side of the honeycomb-type anode-supported matrix with three-dimensional channels, and an oxidizing gas or air is introduced into a side of the cathode layer.

7. The method for preparing a connector-free anode-supported solid oxide fuel cell stack by means of 3D printing according to claim 6, wherein when the impregnation manner I is used, the blank area is an annular area, located at a lower end of each of the intratubal fluid channels, and the annular area has a height of 0.1-1 mm; and
when the impregnation manner II is used, the blank area is an area of all the inter-tube fluid channels formed between an end face resulted from translating, towards an interior of the cell by 0.1-1 mm, a right end face BB′C′C of end faces where the ceramic rib plates are located and the right end face BB′C′C.

8. The method for preparing a connector-free anode-supported solid oxide fuel cell stack by means of 3D printing according to claim 2, wherein the connector-free anode-supported solid oxide fuel cell stack is formed in a manner which is different depending on the different impregnation manner:
when the impregnation manner I is used, an outer surface ABCD of a ceramic tube plate where upper-end tube openings of ceramic microtubes of one anode-supported solid oxide fuel cell are located and an outer surface A′B′C′D′ of a ceramic tube plate where lower-end tube openings of ceramic microtubes of another anode-supported solid oxide fuel cell are located are effectively abutted and sealed, in the manner of cathode-anode-cathode, to form the connector-free anode-supported solid oxide fuel cell stack; and
when the impregnation manner II is used, a left end face AA′D′D of end faces where ceramic rib plates of one anode-supported solid oxide fuel cell are located and a right end face BB′C′C of end faces where ceramic rib plates of another anode-supported solid oxide fuel cell are located are effectively abutted and sealed, in the manner of cathode-anode-cathode, to form the connector-free anode-supported solid oxide fuel cell stack.

9. The method for preparing a connector-free anode-supported solid oxide fuel cell stack by means of 3D printing according to claim 2, wherein the debinding refers to heat treatment in a certain atmosphere at a temperature lower than 800° C. for 5-30 h; the sintering refers to heat treatment in a certain atmosphere at a temperature of 800-1600° C. for 2-10 h, wherein the atmosphere during the debinding is vacuum atmosphere, normal pressure atmosphere or inert gas atmosphere; and the atmosphere during the sintering is oxidizing atmosphere or ordinary atmosphere.

10. The method for preparing a connector-free anode-supported solid oxide fuel cell stack by means of 3D printing according to claim 2, wherein the electrolyte layer has a thickness of 1-20 μm; and the cathode layer is a porous layer, with a thickness of 5-20μm.

11. The method for preparing a connector-free anode-supported solid oxide fuel cell stack by means of 3D printing according to claim 5, wherein:
when the electrolyte layer and the cathode layer are sequentially deposited on the honeycomb-type anode-supported matrix with three-dimensional channels, impregnation is performed in one of two manners including an impregnation manner I or an impregnation manner II:
the impregnation manner I: sequentially impregnating the electrolyte layer and the cathode layer on an outer surface ABCD of a ceramic tube plate where upper-end tube openings of the intratubal fluid channels and the ceramic microtubes are located; and
the impregnation manner II: sequentially impregnating the electrolyte layer and the cathode layer on a left end face AA′D′D of end faces where the inter-tube fluid channels and the ceramic rib plates are located;
wherein when the impregnation manner I is used, in an impregnation process, a blank area is reserved inside each of the intratubal fluid channels, and the blank area is only impregnated with the electrolyte layer, but no cathode layer; when the impregnation manner II is used, in an impregnation process, a blank area is reserved inside the inter-tube fluid channels, and the blank area is only impregnated with the electrolyte layer, but no cathode layer; and
a fuel gas is introduced into a side of the honeycomb-type anode-supported matrix with three-dimensional channels, and an oxidizing gas or air is introduced into a side of the cathode layer.

12. The method for preparing a connector-free anode-supported solid oxide fuel cell stack by means of 3D printing according to claim 6, wherein the connector-free anode-supported solid oxide fuel cell stack is formed in a manner which is different depending on the different impregnation manner:
when the impregnation manner I is used, an outer surface ABCD of a ceramic tube plate where upper-end tube openings of ceramic microtubes of one anode-supported solid oxide fuel cell are located and an outer surface A′B′C′D′ of a ceramic tube plate where lower-end tube openings of ceramic microtubes of another anode-supported solid oxide fuel cell are located are effectively abutted and sealed, in the manner of cathode-anode-cathode, to form the connector-free anode-supported solid oxide fuel cell stack; and
when the impregnation manner II is used, a left end face AA′D′D of end faces where ceramic rib plates of one anode-supported solid oxide fuel cell are located and a right end face BB′C′C of end faces where ceramic rib plates of another anode-supported solid oxide fuel cell are located are effectively abutted and sealed, in the manner of cathode-anode-cathode, to form the connector-free anode-supported solid oxide fuel cell stack.
